(19) United States
(12) Patent Application Publication
(10) Pub. No.: US 2026/0087169 A1
(43) Pub. Date: Mar. 26, 2026

(54) Detecting Secrets in Deleted Software Development Platform Repositories

(71) Applicant: Zscaler, Inc., San Jose, CA (US)

(72) Inventor: Shoham Danino, Tel-Aviv (IL)

(73) Assignee: Zscaler, Inc., San Jose, CA (US)

(21) Appl. No.: 19/253,007

(22) Filed: Jun. 27, 2025

Related U.S. Application Data
(63) Continuation-in-part of application No. 18/892,944, filed on Sep. 23, 2024.

(51) Int. Cl. G06F 21/62; G06F 8/77

(52) U.S. Cl. CPC G06F 21/6245; G06F 8/77

(57) ABSTRACT

Systems and methods for detecting secrets in deleted software development platforms (SDP) are disclosed herein, including querying an SDP for account and repository data, the querying being based on a customer name, identifying previously existing content that is no long present in a current version of the SDP, reconstructing the previously existing content, analyzing the reconstructed content for one or more indicators of sensitive information, and generating a report based on the analysis.

### CROSS-REFERENCE TO RELATED APPLICATION(S)

The present disclosure is a continuation-in-part of U.S. patent application Ser. No. 18/892,944, filed Sep. 23, 2024, entitled “Software Development Platform Repository and Account Discovery”, the contents of which are incorporated by reference in their entirety.

### FIELD OF THE DISCLOSURE

The present disclosure relates generally to networking and computing. More particularly, the present disclosure relates to systems and methods for a cloud-based system configured to discover secrets in deleted software development platform repositories.

### BACKGROUND OF THE DISCLOSURE

Public repositories which can be used to share code, documents, or other information between parties have become essential to modern developers. Specifically, the software development ecosystem tends to use such public software development platforms to facilitate collaboration, knowledge sharing, and remote work situations. Common platforms such as GitHub, GitLab, and Bitbucket are commonly used to host millions of projects in a variety of fields. Moreover, such platforms can provide developers with the ability to contribute to open-source projects, share code collaborate and problem solve, and manage version control. However, along with their benefits, these software repositories pose significant risks particularly concerning the inadvertent leakage of sensitive data, or data which belongs to outside companies.

Sensitive data can refer to information which is private or confidential and need protection from unauthorized access. Such sensitive data can include company or corporate information, private or security information of individuals or organizations, personally identifiable information, credential, API keys, passwords, private keys, proprietary code, and business critical information. Given the millions of users who frequent public repositories, sensitive data leaks are bound to happen through the public repository. When such data is unintentionally included in public repositories, its security is compromised, which can pose severe security threats.

The consequences of security breaches through public repositories can be widespread. For example, the unintentional dissemination of code through the public repository can include security breaches through exposed credentials, identity theft, leakage of PII, intellectual property theft, the loss of proprietary code and critical information, regulatory compliance issues, and erosion of trust. The state of the art currently includes labor intensive monitoring and audits which can be otherwise ineffective or marginally effective given the vastness of public repositories. The code or information can then be removed once it is identified through the monitoring. Such monitoring is often performed manually and can be resource and labor intensive.

One particularly overlooked threat vector arises from the historical nature of version control systems such as Git. Even when sensitive data is removed from the active files in a repository, prior versions containing the exposed data may remain accessible through Git commit history. Malicious actors can exploit this by traversing historical commits to recover deleted credentials, tokens, or other confidential information. These artifacts, preserved in the repository's internal structures, are retrievable using standard Git commands—often unbeknownst to the original developer. Without purpose-built tools to analyze historical states of repositories, organizations lack sufficient visibility into what sensitive data may have been exposed and subsequently deleted, leaving them vulnerable to persistent data leakage risks. It is clear that there exists a need in the state of the art not yet met for increasing the speed and efficiency of finding sensitive code or information on public software repositories which have been deleted.

### BRIEF SUMMARY OF THE DISCLOSURE

The present disclosure relates to systems and methods for identifying information in public software development platform sharing repositories. The method can be used to research a given customer's public software repositories and can then be used to scan the code for data leakage. The method can include querying a software development platform such as GitHub for data. The data can be account data or repository data. From there, the data can be analyzed based on a variety of parameters. Such analysis is configured to search for a variety of parameters. A score can be generated based on the results of the search which can be used to label or identify the accounts. The score can be used to determine the likelihood of the account belonging to the customer based on the score. A more thorough analysis can be conducted based on the likelihood of the account belonging to the customer associated with a company of interest.

In other aspects, the present disclosure provides systems and methods for detecting sensitive information in deleted content from public software development platforms. The disclosed method can querying a software development platform, such as GitHub or Bitbucket, for account and repository data associated with a particular customer. Once relevant repositories are identified, the system can detect content that previously existed but is no longer present in the current version of the repository. This deleted or modified content can be reconstructed using internal version control data and commit history. The reconstructed content can then be analyzed for indicators of sensitive or confidential information, such as access tokens, credentials, or proprietary information. Based on this analysis, a report can be generated, which may include risk indicators, commit references, and file-level insights that help inform security teams or compliance workflows

In one aspect, disclosed is a method implemented by a cloud-based system, the method comprising steps of querying a software development platform for account and repository data, the querying being based on a customer name, for each account of a plurality of accounts, analyzing associated account and repository data, generating a score for each account of the plurality of accounts based on the analyzing, the score being indicative of an account belonging to the customer, and labeling one or more accounts of the plurality of accounts as belonging to the customer based on the score.

In a further aspect, disclosed is a non-transitory computer-readable medium comprising instructions that, when executed, cause one or more processors to perform the steps of querying a software development platform for account and repository data, the querying being based on a customer name, for each account of a plurality of accounts, analyzing associated account and repository data, generating a score for each account of the plurality of accounts based on the analyzing, the score being indicative of an account belonging to the customer, and labeling one or more accounts of the plurality of accounts as belonging to the customer based on the score.

In yet another aspect, disclosed is are systems and methods for detecting secrets in deleted software development platforms (SDP), including querying an SDP for account and repository data, the querying being based on a customer name, identifying previously existing content no long present in a current version of the SDP, reconstructing the previously existing content, analyzing the reconstructed content for one or more indicators of sensitive information, and generating a report based on the analysis.

In yet another continuing aspect, disclosed is a non-transitory computer-readable medium comprising instructions that, when executed, cause one or more processors to perform the steps querying an SDP for account and repository data, the querying being based on a customer name, identifying previously existing content no long present in a current version of the SDP, reconstructing the previously existing content, analyzing the reconstructed content for one or more indicators of sensitive information, and generating a report based on the analysis.

### BRIEF DESCRIPTION OF THE DRAWINGS

The present disclosure is detailed through various drawings, where like components or steps are indicated by identical reference numbers for clarity and consistency.

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a flow chart of an exemplary EASM process in accordance with one aspect of the instant disclosure.

FIG. 6 is a flow chart of an exemplary data gathering process in accordance with one aspect of the instant disclosure.

FIG. 7 is a flow chart of an exemplary calculation process in accordance with one aspect of the instant disclosure.

FIG. 8 is a flow chart of a process for public SDP repositories locating in accordance with another aspect of the instant disclosure.

FIG. 9 is a flow chart depicting an exemplary workflow configured to parse commit histories and match detected data in accordance with an aspect of the present disclosure.

FIG. 10 is a flow chart of a process for locating deleted or orphaned information in public SDP repositories in accordance with another aspect of the disclosure.

### DETAILED DESCRIPTION OF THE DISCLOSURE

Again, the present disclosure generally relates to systems and methods which can be used in identifying sensitive data on an online repository platform. Some systems and methods can be configured to identify parameters which are associated with a user and identify such parameters on online data repositories. The method can be implemented by a user device or optionally in the cloud. The method can query a database, such as a software development platform for data, such as account, user, or repository data. The query can be based on customer information or tenant information. It is envisioned that each account of a plurality of accounts can be queried. Systems and methods of the instant disclosure can be configured to analyze at least one of the accounts. A score based on the analysis can be provided based on at least the querying. The score can provide a quantitative estimate of how likely the user is associated with the customer or tenant. A label can be provided based on the score.

Additionally, the instant application generally relates to network security and External Attack Surface Management (EASM). It is envisioned that the methods and systems of the present disclosure can be configured to increase the efficiency and accuracy of identifying sensitive information which could have been, for example, introduced on an online data repository platform. Some methods can include a calculation based on the query of the customer information, and optionally a verification flag which can be defined based on the calculations. More generally, the verification flag can be a label assigned to an account in the SDP. The label can represent if the account is verified, providing a level of legitimacy to the account. Some systems and methods can be configured to operate on public servers or via the internet and can optionally require authentication. Moreover, some aspects of the method herein do not require authentication because the method operates with publicly available data.

The methods and systems described herein can be part of an EASM solution and can provide key data regarding a customer's attack surface. More specifically, methods of the disclosure can control or query online software repositories as a potential attack surface source. For example, the method can query a Software Development Platform (SDP) to identify a potential attack surface source. The method can determine or partially determine which users of a plurality of users engaged with the SDP are associated with the customer or tenant. The method can include a process which is configured to examine the SDP associated with a user to identify sensitive data leakages. Advantageously, the process can determine which users out of all the SDP users to examine without the customer or tenant providing any additional data other than the customer's information such as the customer's company name or company domain. In other words, the method can target users and identify sensitive data leaks such as passwords, keys, tokens, or the like which has been inadvertently uploaded to an SDP without requiring further sensitive information from the customer or tenant. The process provides the customer or tenant with broad visibility of its public users and SDPs which can be accessed by anyone. And be alerted in case of data leakage from those repositories. Again, the method of the instant disclosure can provide visibility of some or all customer's public SDP repositories and detection of sensitive information or data in the public SDP repositories.

Further, the method can further provide a framework structured to retrieve and analyze deleted content from online repository platforms, thereby enhancing the detection of exposed secrets. For example, the system can use Git internals to programmatically identify and reconstruct deleted files by parsing commit histories via version control commands, such as git log, and extracting historical file snapshots. The framework can be orchestrated in a distributed manner, enabling automated handling of large volumes of repositories through temporary, isolated processing environments. Once file recovery is complete, the system can apply multiple layers of secret detection, including pattern-based scanning using regular expressions, entropy-based identification of cryptographic material, and machine learning models capable of flagging ambiguous or custom-defined secret formats. The results can then be aggregated and reported with actionable insights, such as commit references, repository metadata, and secret classification, allowing for proactive mitigation of security risks even in previously purged or deleted content.

In some aspects, the techniques described herein relate to a method implemented by a cloud-based system, the method including steps of: querying a software development platform (SDP) for account and repository data, the querying being based on a customer name; identifying previously existing content that is no long present in a current version of the SDP; reconstructing the previously existing content; analyzing the reconstructed content for one or more indicators of sensitive information; and generating a report based on the analyzing.

In some aspects, the techniques described herein relate to a non-transitory computer-readable medium including instructions that, when executed, cause one or more processors to perform steps of: querying a software development platform (SDP) for account and repository data, the querying being based on a customer name; identifying previously existing content that is no long present in a current version of the SDP; reconstructing the previously existing content; analyzing the reconstructed content for one or more indicators of sensitive information; and generating a report based on the analyzing.

### § 1.0 Cybersecurity Monitoring and Protection Examples

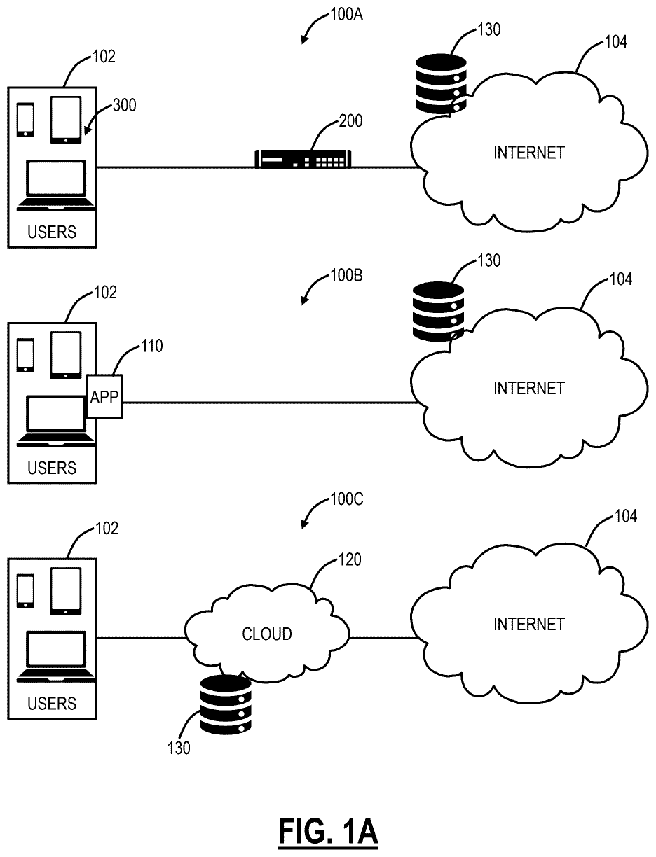

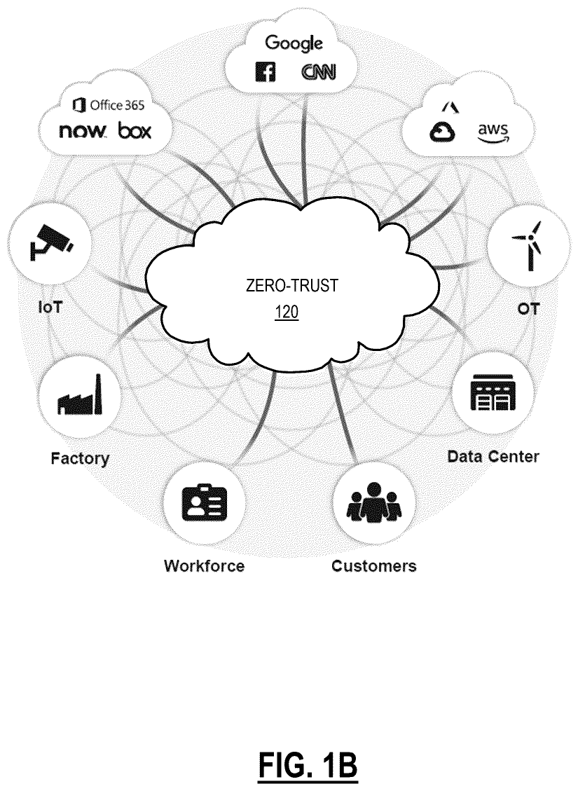

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

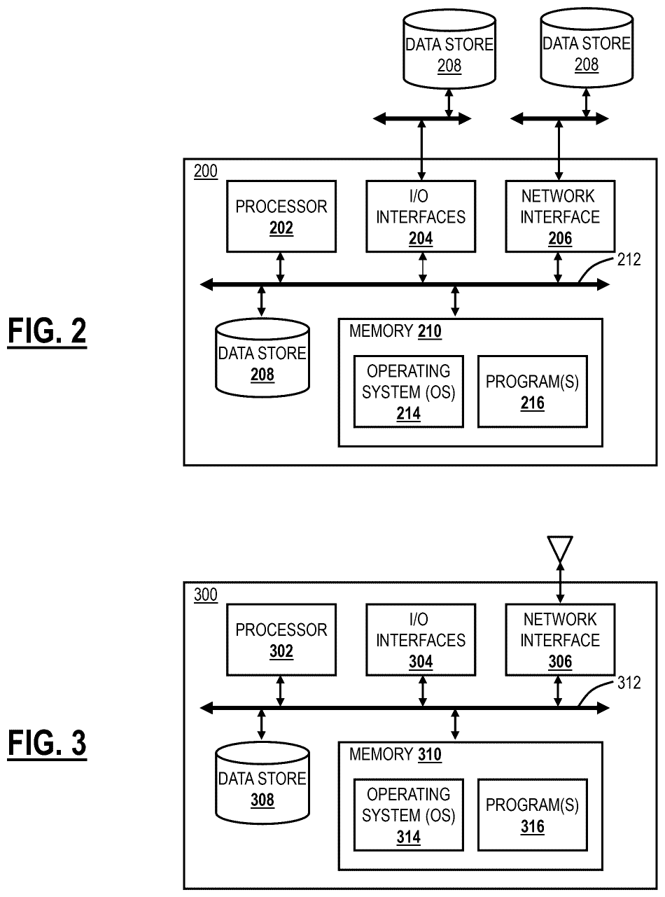

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, loT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located in line with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as related to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (loT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality through the cloud 120.

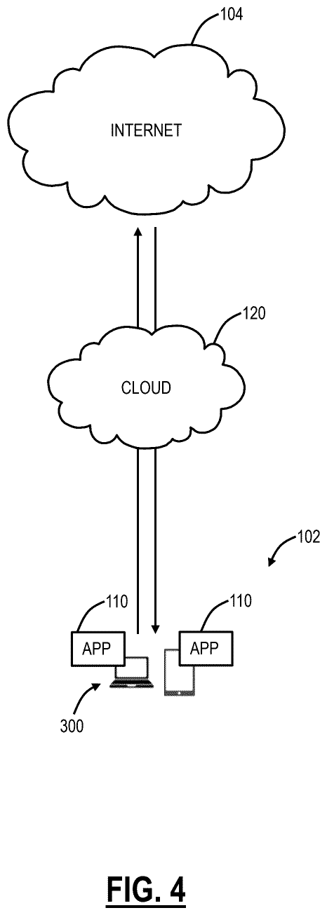

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public or private could or the datacenter and routes mobile traffic through the cloud 120. The application 110 can support various cloud services, including ZIA, ZPA, ZDX, etc., allowing the best-in-class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc., and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 Data Gathering

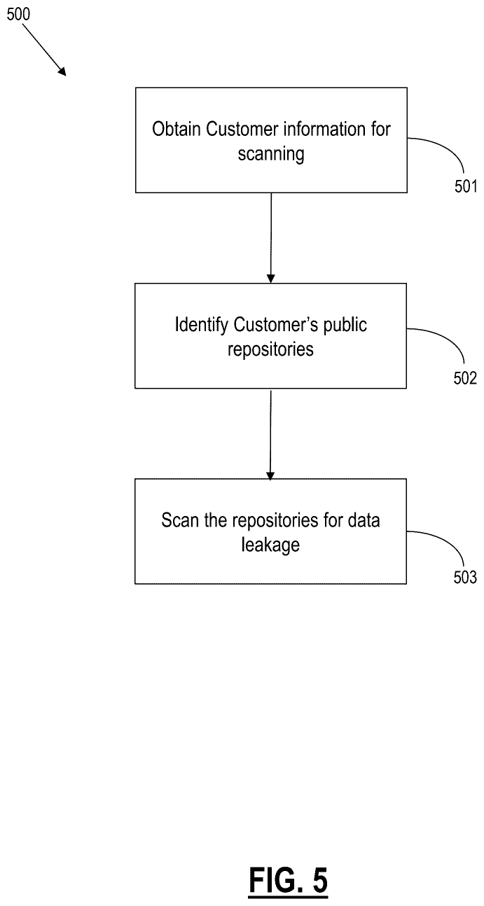

Turning now to FIG. 5, a flowchart of an External Attack Surface Management (EASM) method 500 is shown and described. The method 500 can include a plurality of steps for calculating an attack surface of a tenant of the cloud-based system (cloud 120). As used herein, the term “attack surface” generally refers to all the possible points of entry an attacker can exploit to gain unauthorized access to a system or network. A common attack surface can include Software Development Platform (SDP) data leaks. The SDP can be any public online service configured to provide tools, infrastructure, and data sharing for software development. Some SDPs can provide online collaboration platforms and can be publicly accessible. Examples of SDPs can include, without limitation to, GitHub, GitLab, BitBucket, SourceForge, CodePen, or any platform where one or more users can share and provide public access to data, such as computer code. A user can be any individual engaging with the SDP. Some methods can include an obtaining information step 501, an identifying repositories step 502, and a scanning 503 repository step. In some aspects, the SDP can be the attack surface.

In some aspects, the obtaining information 501 can include obtaining any information relative to a customer. The customer can be any entity, individual, or the like who is seeking EASM or using any portion of the methods and systems described herein. Information for the obtaining information 501 can include any information about the customer, which is publicly available, for example, information regarding the customer available on the internet. For example, such information can include domain names, website URLs, a company name, or the like. Some methods can use the company name as the customer information for scanning. As such, one example of the method 500 can include obtaining customer information for scanning 501, wherein the customer information is the name of the customer. In some aspects, the customer is the tenant.

One aspect of the method 500 can include identifying 502 the customer's public repository. The repository can be identified 502 on an SDP, for example GitHub. More generally, the identifying 502 can identify if/which SDP is associated with the customer. The identifying 502 can identify the SDP based on the customer information or data and SDP data. The method 500 can include scanning 503 the SDP for data leakage. The scanning 503 can include a process of scanning the data on a repository of the SDP for sensitive or confidential data. Sensitive data can include passwords, keys, tokens, code, and other confidential or undisclosed information. The scanning 503 can be responsive to the identifying 502 positively identifying that the SDP or repository belongs to the customer. More generally, the scanning 503 can involve scanning an identified repository. In some aspects, the method 500 can include any of the obtaining 501, the identifying 502, and the scanning 503. The method 500 can include first obtaining 501 customer information for scanning, then identifying 502 customer's public repositories on the SDP, and then the scanning 503 the repository for data leakage of sensitive data.

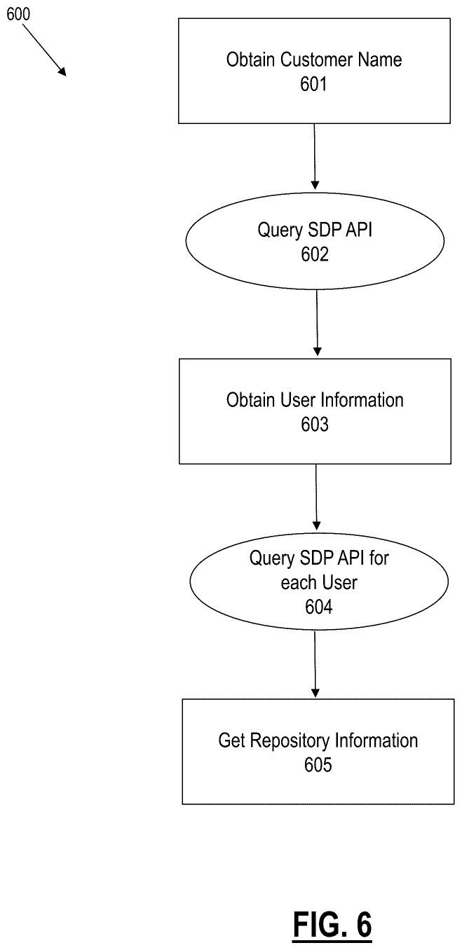

Turning now to FIG. 6, an alternative embodiment of a data gathering method 600 is shown and described. The data gathering method 600 can include obtaining the customer's name 601. The customer's name can be any name or tag associated with the customer. In example, the customer's name can be the common market name or trade name of the customer. The customer's name can include trademarks or other identifying labels or titles. The data gathering method 600 can include querying the SDP's API 602. For example, only the data gathering method 600 can include querying GitHub's API for information. The information can include data, parameters, or the like related to a plurality of users. In typical aspects, the querying the SDP API 602 can include defining one or more verification flags. The data gathering method 600 can include obtaining user information 603. The querying the SDP API 602 can define a first query. The obtaining user information 603 can be any parameter or data related to the user. For example, the user information can be a username, a profile picture, a user account creation data, a user account upload date, a website link, or any similar information related to the user. The data gathering method 600 can include a querying the SDP API for each user 604. The querying the SDP API for each user 604 can define a second query to the SDP API. The data gathering method 600 can include a getting repository information 605 step. The getting repository information 605 can include gathering data or parameters of a certain repository which is connected to the user. It is envisioned that the data gathering method 600 can identify which repositories of a plurality of repositories have a higher likelihood of being associated with the customer.

### § 5.1 Account Score Calculation & Identification

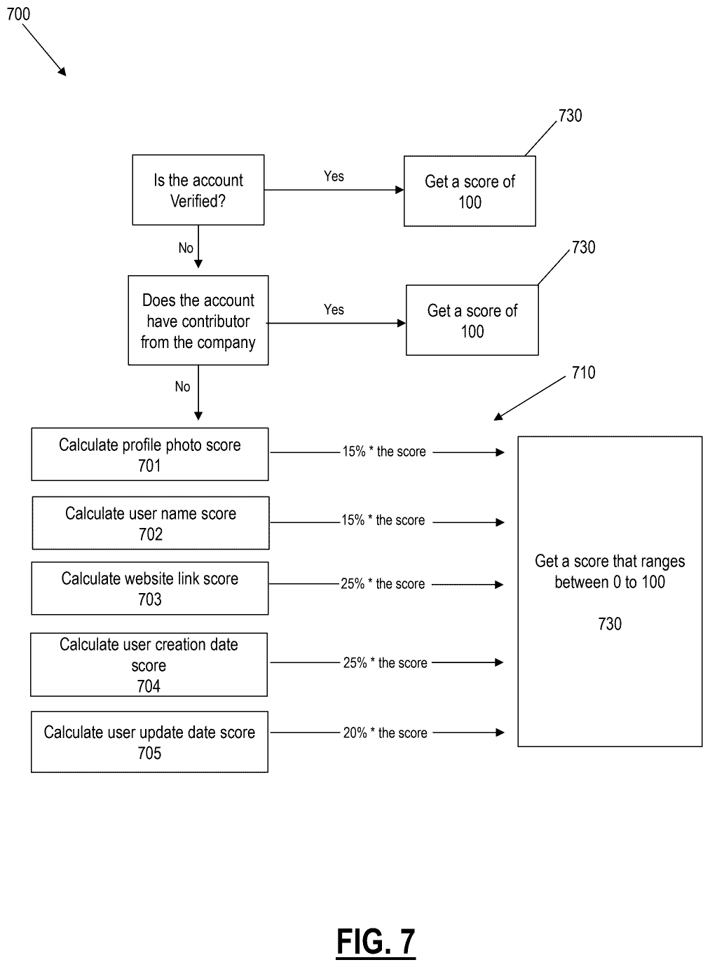

Turning now to FIG. 7, a flowchart for a calculation process 700 for the identification 502 is shown and described. The calculation process 700 can be configured to identify the likelihood that an SDP account is associated with a tenant. In one aspect, the calculation process 700 can include a query. The query can be based on an Application Programming Interface (API). For example, the query can interact with the API of the SDP, for example the API of GitHub. In an example embodiment without limitation, the query can query the GitHub API to get information, such as user information. The method can include a plurality of queries wherein one or more of the plurality of queries interact with the SDP API. The method can include getting repository information based on a user/account. More generally, the method can include, for each user, querying the SDP API to get all repository information related to the user. The query can be based on the customer's company name, or any other public information about the company. Importantly, the information related to the customer for the query can be publicly available. It is envisioned that, as a result of the public nature of the query information, no special authentication is required. In general, the query can identify if the repository belongs to the customer. The method can include scanning an SDP to determine if one or more repositories are associated with a user that is affiliated with the company. The method can also include scanning for repositories which contain information associated with the customer. For example, the query and more generally, the method can include scanning users and/or repositories which might contain information belonging to the company. In an exemplary aspect, the method can scan users and repositories for data which contains, for example, the name of the customer's company.

Once the repositories within an SDP are identified, the method can extract one or more attributes. In some aspects, a multiplicity of attributes is extracted. The method can make a request to the SDP API endpoint to retrieve attributes or manipulate data. The query can be a structured request and return response, wherein the response defines the attributes. In some aspects, the process can query all users and organizations in the SDP which contain the customer's name. The method can be configured to extract the attributes, which include without limitation a username, a verification flag, a profile photo, a website link, a creation date, an update date, and other repository related data. In some aspects, the process can extract one or more attributes from each repository of a user. For example, for each repository of the user or organization, one or more attributes can be extracted. In further example, such extracted attributes can define, but are not limited to a creation date of the repository, an update date of the repository, and a one or more contributors to the repository.

The calculation process 700 can determine if the account is verified. More specifically, the calculation process 700 can determine if the user account of the SDP actually belongs to the user. The query can identify if an account is verified and/or belongs to the customer or user. Similarly, the calculation process 700 can determine if the account has a contributor belonging to the company. More generally, the calculation process 700 or query can determine if one or more contributors of the repository are associated with the customer, for example via the customer name. In example only, and without limitation, the calculation process 700 can determine if the user of the SDP bears any resemblance to the customer by sharing a common name, for example the name of the customer or company name.

The calculation process 700 can extract a profile photo 701. The profile photo 701 can be an image associated with the user's account and can be used to visually represent the user in the SDP. The calculation process 700 can extract a username 702. The username 702 can be a piece of information for authentication and can typically serve as a unique identifier for a user account. The calculation process 700 can extract a website link 703 which can be compared to the customer's website. The calculation process 700 can extract a user creation date 704, wherein the user creation data results from the timestamp of the creation of the repository based on the user. The calculation process 700 can extract an update date 705. The update date 705 can correspond to latest date the repository was updated by a user.

In some aspects, the calculation process 700 can assign a score 730 as a result of the parameters being considered. The score can range from 0 to 100 and can be adapted to assess the degree of similarity between the user and the company. For example, based on at least one portion of the process described herein, the process can evaluate the parameters and provide a score, wherein the score increases as the likelihood as determined by the process increases of the user being associated with the customer. For example, if the process determines that the user account is verified, then the calculation process 700 can assign a score 730 of 100 to the user account and establish that the account is very likely associated with the customer. In further example, the calculation process 700 can determine if the user account or repository has a contribution or contributor from the company. If the determination is yes, then the process can assign a score of 100 to the account or user and determine that the account is highly likely associated with the company. The score 730 can be automatically assigned or calculated. For example, if the calculation process 700 or query determines that the account is verified, the calculation process 700 can automatically assign a score of 100 to the account. In an alternative example, if the account is not verified and no contributor from the company is identified, then one or more parameters can be used to calculate the score 730 which can range between 0 and 100.

The calculation process 700 can compare the username 702 to the company name to assess the degree of similarity. If the username 702 of the user matches the name of the customer, the calculation process 700 can assign the username 702 attribute a score of 100. If the name of the customer is included in the username 702 of the user, the calculation process 700 can assign the username 702 attribute a score of 85. If there is no match between the customer's name and the username 702 of the user, the calculation process 700 can assign the username 702 attribute a score of 0. In some aspects, each user or organization can define a verification flag. The verification flag can be a Boolean or status indicator used to signify whether a certain process, action, or condition has been validated. Each user or organization can define a unique verification flag. Each verification flag can define a true state or a false state, wherein the true state can represent that the user has been verified and the false state can represent that the user has not been verified. The calculation process 700 can give a score 730 of 100 to the user or organization if the verification flag of the user is set to true. The calculation process 700 can give a score 730 of 0 to the user or organization if the verification flag of the user is set to false. Again, as the score 730 increases, the likelihood of the user or data repository being associated with the customer increases.

The calculation process 700 can scan for the profile photo 701. If the user has a profile photo 701 attribute, the calculation process 700 can compare the profile photo 701 to a list of photos associated with the customer, for example a photo of a company logo. The company photo can be obtained from the internet. The profile photo 701 of the user can be compared to the company photo, such as the company logo with a photograph comparison algorithm. The photograph comparison algorithm can be any photograph comparison algorithm known to one of skill in the art. In example only, and without limitation, the photograph comparison algorithm can be a Favicon Comparison algorithm. If the profile photo 701 of the user is detected as being very similar the customer's logo, the calculation process 700 can give the user a score 730 of 100 for the profile photo score. If the profile photo 701 of the user/account is not similar to the customer's logo, the calculation process 700 can give the user/account a score 730 of 0 for the profile photo score. It will be appreciated that the profile photo score 701 can range between 0 and 100 based on the similarity of the profile photo to the company's logo.

The website link 703 can be an attribute associated with the user. Moreover, the website link 703 can be published by the user on the account or repository. The website link 703 can be a dedicated attribute of the user. If the SDP, such as and with limitation GitHub user account contained the website link 703 that has been published, the calculation process 700 can compare it to the customer's website. If the website link 703 as published by the user is detected as the customer's website, the calculation process 700 can give the website link 703 attribute a score 730 of 100. If the website link 703 published by the user is not detected as the customer's website, the calculation process 700 can give the website link 703 attribute a score 730 of −1. If the user does not publish the website link 703, the calculation process 700 can give the website link 703 attribute a score 730 of 0. In general, if the website link 703 matches the website of the customer, the user is typically associated with the customer, and if the website link 703 does not match the customer's website, the user is most likely not associated with the customer. The creation date 704 can be the timestamp or age of the user account on the SDP. In general, the older the user, the more likely that the user is an original customer's user. Conversely, newer user accounts can indicate that the user account is more likely a fake. For example, if a malicious user wanted to create a phishing user, most likely the user will be newer than older. Therefore, in various embodiments, if the user was created more than 365 days ago from the timestamp of the query, the calculation process 700 can give the creation date 704 attribute a score 730 of 100. If the user was created more than 180 days ago from the timestamp of the query, the calculation process 700 can give the creation date 704 attribute a score 730 of 80. If the user was created more than 30 days from the timestamp of the query, the calculation process 700 can give the creation date 704 attribute a score 730 of 50. If the user was created more than 7 days from the timestamp of the query, the calculation process 700 can give the creation date 704 attribute a score 730 of 10. If the user was created less than 7 days from the timestamp of the query, the calculation process 700 can give the creation date 704 attribute a score 730 of 0. The user update date 705 score 730 can be calculated based on the same logic and method as the user creation date 704 score.

The calculation process 700 can identify the user based on any combination of parameters described herein and can assign a score based on one or more of the parameters. For example, the calculation process 700 can provide the score 730 based on the aggregate score 730 of multiple parameters, wherein the aggregate score can be derived from a weighted summation. Again, the calculation process 700 can generate the score 730 based on the parameters, wherein the score is related to the user. The score 730 can range between 0 and 100, as the score increases with the likelihood that the user is associated with the customer. In example only, the calculation process 700 can first obtain customer or tenant information, such as the name of the customer. The calculation process 700 can query the SDP API to obtain one or more user attributes for one or more users. The calculation process 700 can query the SDP API for each based on all user information. In some aspects, the calculation process 700 can define the score 730, wherein the score is a weighted sum defining the likelihood the user is associated with the customer. The following table provides an exemplary weighting scheme 710 for the example parameters discussed.

| | Weighted Value |
|---|---|
| Parameter | (Percentage of the score) |
| Profile Photo | 15% |
| Username | 15% |
| Website Link | 25% |
| User Creation data | 25% |
| User Update date | 20% |
| Verified Account | If yes - Score of 100 |
| Company Contributor | If yes - Score of 100 |

In an example only, and without limitation, if the calculation process 700 identifies a user of the plurality of users identified in a query, the process queries the user or user account for any of the parameters above. If in example, the user account includes a profile picture which matches the company logo, a website link which matches the company website, and has a username which does not match the company username, the calculation process 700 could generate the following score 730 for the user:

$$Score = \sum ( observed attributes score ) ( weighted value of attribute ) = ( 100 ) \text{.15} + ( 100 ) \text{.25} + ( 0 ) \text{.15} = 40$$

The calculation process 700 can query data related to repositories associated with each suspected user and/or organization. The suspected user and/or organization can be determined based on the score 730. The process can use an API call to get information about the repositories associated with suspected users. Alternatively, the calculation process 700 can include an API call to get information related to the contributors of a given repository. More generally, the Calculation process 700 can include scanning a repository for information, data, or attributes. For each suspected user and/or organization, the calculation process 700 can query data related to any of the associated repositories and can perform checks. The checks can scan for attributes via, for example, an API call. The calculation process 700 can scan each repository for attributes. The repository can define a repository creation date. In some aspects, the older the repository is, the more likely the repository is associated with an original customer's repository. Concurrently, the younger the repository's creation date, the more likely the repository is fake. The repository creation date score can be calculated mutatis mutandis to the creation date 704 score.

The calculation process 700 can query the API of the SDP to identify a repository update date parameter. In some aspects, the later the repository was updated the more likely that the repository is a real, live, and/or updating repository associated with the user. Concurrently, the earlier repository update date, the more likely the repository is fake. The repository update date score can be calculated Mutatis Mutandis to the update date 705 score. The calculation process 700 can scan users and/or repositories based on an API call to identify contributors. In some aspects, for each repository, the calculation process 700 can extract some or all details of the repository's contributors. If the contributors define a common email address, the calculation process 700 can check if the contributors' email addresses belong to the company based on the domain name. If the email addresses belong to the company, the score of the user and/or organization that owns the repository can be given a score 730 of 100. The calculation process 700 can determine that the repository belongs to the customer.

Once the repository or repositories are identified, the calculation process 700 can include scanning the identified repository for sensitive information. Importantly, the calculation process 700 is adapted to quickly identify suspicious users and/or accounts much faster and potentially with greater accuracy than a human. The process can be implemented on a computing device. Again, the calculation process 700 can, once the repository associated with a suspicious account has been identified, scan the repository for data leakages or sensitive information, thereby detecting data leakages or sensitive information associated with a tenant within an SDP.

### § 5.2 Process for Automatic SDP Repository Identification

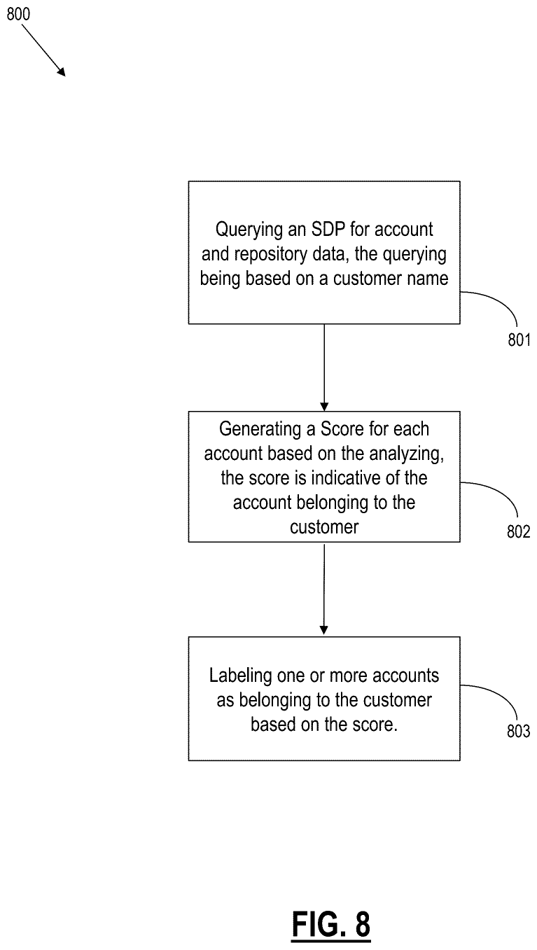

Turning now to FIG. 8, a process 800 for automatically identifying public SDP repositories is shown and described. The process 800 can include querying 801 an SDP for account and/or repository data. The querying 801 can be based on customer information, for example a customer name. The process 800 can include generating 802 the score 730 for each account of the plurality of accounts based on the analyzing. The score 730 can be indicative of an account belonging to the customer. The process 800 can include labeling 803 one or more of the accounts of the plurality of accounts as belonging to the customer based on the score.

The process 800 can include the account and/or repository data defining parameters including without limitation the username, the profile picture, the website link, the creation date, the update date, repositories, and associated repositories. The repository data can include a creation date, an update date, and contributors. The contributors can be any users associated with the repository. The process can include wherein the score is a composite score based on any of the profile photo, the username, the website link, and the user creation date. The process 800 can include wherein the account and repository data further include the username, and wherein the analyzing further includes comparing the username to the customer name via a one or more name comparison model. The process can implement a name comparison model. The name comparison model can be implemented by the process and can match or compare names across different data sets or inputs. The name comparison model can include fuzzy matching, exact matching, and can optionally use machine learning algorithms to compare names based on various characteristics. The process 800 can implement a photo comparison model. The photo comparison model can be a model implemented by network software and can be configured to determine whether two images belong to the same entity or if they are similar. The photo comparison model can include image preprocessing, normalization, character detection, deep learning-based detectors, Haar cascades, feature extraction, similarity measurements, and classification schemes.

The process 800 can include wherein the account and repository data includes a verification flag, and wherein the analyzing further includes determining for each of the plurality of accounts, if the verification flag is present. Again, the verification flag can be a label to signify if the SDP account has been verified. The process 800 can include wherein the account and/or repository data includes the website link, and wherein the analyzing further includes comparing the website link to a known customer website link. In other aspects, the process 800 can perform a check to determine if the website link is associated with the customer. The process 800 can include wherein the account and repository data includes a creation date, and wherein the analyzing further includes comparing the creation date to a current date and determining an age of the account and/or repository data.

The process 800 can include wherein the account and repository data further include an update date, and wherein the analyzing further includes comparing the update date to a current date and determining a duration between the current date and the update date. The process 800 can include wherein the account and/or repository data includes one or more contributor details, and wherein the analyzing further includes determining if the one or more contributor details belong to the client via a contributor detail verification model.

### § 6.1 Historical SDP Data Recovery

Git repositories are commonly used in modern software development workflows. While they provide positive synergistic opportunities amongst developers, they present unique challenges from a security perspective. Sensitive information, such as and without limitation API keys, tokens, and credentials can be mistakenly committed by developers. They can be accordingly removed later. Despite deleting from the active view, SDP platforms, for example, Git commit history can retain these files, making it possible for attackers to mine historical commits for secrets. Tools which concentrate solely on scanning active files may not address a gap presented by deleted files in historical commits. One aspect of the present disclosure pertains to an automated workflow to retrieve deleted files from SDP repositories and optionally subsequently scanning them for exposed secrets.

Notably, embodiments of the systems and methods presented herein are operable to detect data which would otherwise be invisible. Traditionally, scanning tools ignore non-active files. General aspects of the systems and methods of the present disclosure are configured to detect and scan deleted or historical files in SDP repositories. Attackers who are mining Git logs can weaponize improperly removed credentials. Typical aspects of the present disclosure can be configured to lower the exploitation risk of sensitive information in an SDP repository. Additionally, the sheer volume of commits in large repositories makes manual processes impractical or impossible. Typical aspects of the disclosure provide systems and methods for automation and scaling of historical commit data scanning and detection.

In some embodiments, the disclosed systems are implemented using specialized orchestration logic and repository parsing modules that operate in a distributed computing environment, thereby improving the speed, accuracy, and feasibility of processing large-scale version control data. The automation is not merely a generic computer implementation, but rather involves concrete, technical steps including low-level Git command execution, dynamic reconstruction of file states, and parallelized detection pipelines configured to handle repository-specific metadata and commit trees. As such, the claimed invention improves the functioning of computing systems themselves by enabling efficient and scalable analysis of codebase histories that would otherwise be computationally prohibitive using conventional techniques.

The present disclosure proposes a scalable, automated framework which can systematically retrieves deleted content from software repositories and scans it for exposed secrets. In various embodiments, the framework leverages Git internals, including but not limited to git log, git diff, git rev-list, and git show, to traverse commit histories, identify deleted files or content, and reconstruct prior file states based on commit references. For example, when a developer removes a file containing an API key and commits the change, the system can identify that the file was deleted, extract its contents as of the last commit in which it existed, and analyze the contents for sensitive data such as hardcoded credentials.

Embodiments can include a detection engine configured to match file contents against known secret patterns, such as regular expressions corresponding to OAuth tokens, private keys, database connection strings, or cloud provider access credentials (e.g., AWS access keys, Google service account keys). In some embodiments, the detection engine further incorporates entropy-based heuristics to flag high-entropy strings typically associated with cryptographic artifacts. Additionally, machine learning models may be used to identify novel or ambiguous secret formats, including user-defined environment variable keys that do not match predefined patterns but exhibit suspicious contextual usage.

The framework is designed for automation and scaling across multiple repositories and organizations. In one embodiment, the system automatically clones a target repository into a temporary containerized environment, performs commit traversal and file reconstruction within that environment, and tears down the environment upon completion. In another embodiment, the system can interface with repository hosting platforms (e.g., GitHub, GitLab, Bitbucket) via API to selectively retrieve and analyze commit data without full repository cloning. This improves processing efficiency and reduces resource consumption.

In some implementations, the system is deployed across a distributed compute infrastructure such as Kubernetes or a serverless architecture, allowing concurrent analysis of multiple repositories or commits. Job scheduling logic may allocate resources dynamically based on repository size, age, or commit frequency. The system may also be configured to scan specific branches (e.g., main, dev, release) or time windows (e.g., commits made within the past 12 months), thereby offering tunable sensitivity and reducing false positives. In alternate embodiments, the framework supports integration into CI/CD pipelines to provide real-time or pre-merge secret scanning. For example, a Git pre-receive hook or webhook can trigger the system upon push events, enabling detection and remediation of exposed secrets before they reach production branches.

More generally, the disclosed framework can be a solution to the technical problem of secret exposure through deleted content in source control systems. By automating and scaling the retrieval and scanning process across historical commit data, the invention improves security posture while avoiding the computational impracticalities of manual inspection. The disclosure proposes a scalable, automated framework which can systematically retrieve deleted content from repositories and scan the information for secrets. The workflow can use Git internals to parse commit histories and match detection data against known secret patterns. Environments

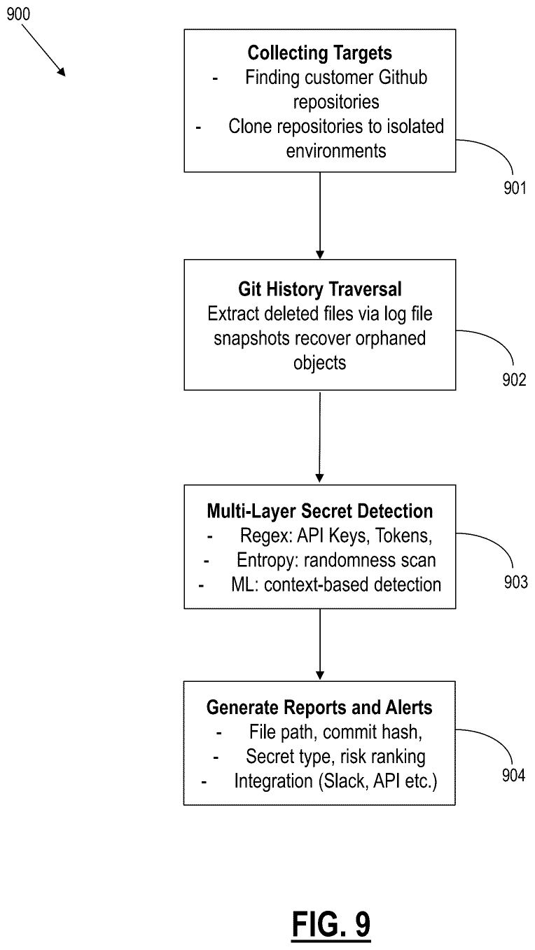

Turning now to FIG. 9, a flow chart depicting an exemplary workflow 900 configured to parse commit histories and match detected data is shown and described. In some aspects, the workflow 900 can include a retrieving step 901. The retrieval 901 can be retrieving deleted files. For example, the retrieval 901 can be using “git log” to list all deleted files. For each deleted entry, the method can reconstruct the file snapshot using its last reference. In example only, the retrieval 901 can be collecting targets, including finding customer Github repositories and cloning repositories to isolated environments.

The retrieval 901 can include retrieving deleted files or content from a version-controlled software repository. In one embodiment, the retrieval 901 comprises using Git commands, such as git log--diff-filter=D--summary, to identify all files that have been deleted in the commit history of a repository. The method can iterate through each commit where a deletion event occurred and, for each deleted entry, reconstruct the corresponding file snapshot using its last known reference. For example, the method can use git show <commit-hash>:<filepath> to extract the contents of the deleted file as it existed just prior to its removal.

In some embodiments, retrieval 901 can also include parsing the full commit tree using git rev-list or git log--all to ensure that deleted files from all branches, not just the default branch (e.g., main or master)—are considered. This allows for a more complete historical analysis, capturing sensitive data that may have been committed and deleted in non-primary branches. In one example, a customer's public or private GitHub repositories may be programmatically discovered and designated as scanning targets. The retrieval 901 can include identifying repository URLs associated with a specific customer domain (e.g., @customer.com) by querying a software development platform (SDP) API or analyzing public metadata associated with Git commits (e.g., author emails). Once identified, each repository can be cloned or mirrored into an isolated execution environment, such as a container (e.g., Docker) or a serverless function (e.g., AWS Lambda), to ensure that scanning processes do not affect live development environments.

In alternate embodiments, retrieval 901 may be performed without cloning the full repository. For instance, the method can leverage partial clone or shallow clone techniques (e.g., git clone--depth=1) to minimize data transfer and accelerate scanning. Alternatively, the system may interface with platform APIs (e.g., GitHub's GraphQL or REST APIs) to retrieve commit metadata and file diffs directly, reducing storage and compute overhead. Additionally, in some implementations, the retrieval 901 can be governed by configurable scope parameters. For example, the system may be configured to retrieve only files deleted within a certain timeframe (e.g., the past 90 days) or files deleted from specific directory paths (e.g., /config/, /secrets/). This allows for more targeted and efficient scanning, particularly in large repositories with extensive commit histories.

In another embodiment, retrieval 901 can include identifying deleted content not only from files but also from lines within files. For example, the method can use git blame and git diff to detect when sensitive lines, such as an embedded token or password, were removed from an otherwise unchanged file, and reconstruct those lines for downstream analysis. This fine-grained retrieval capability can be configured to ensure that partial deletions do not evade detection. In some cases, the retrieval 901 process may also include metadata enrichment. For instance, each deleted file or content snapshot can be tagged with contextual information such as the commit timestamp, committer identity, commit message, and branch name. This metadata can be used in subsequent processing stages to assess the severity, recency, or risk level of the detected content.

In typical aspects, the workflow 900 can include a scaling 902 step. The scaling 902 can be a scaling with automation or more specifically, a Git history traversal. The scaling 902 can extract deleted files via logs, restore file snapshots, recover orphaned objects. More generally, the scaling 902 can automate repository handling with distributed orchestration. Optionally, the scaling 902 can build temporary environments for isolated processing or each repository. The scaling 902 can include scaling with automation, and more specifically, can comprise scalable Git history traversal and automated data extraction processes. In various embodiments, the scaling 902 automates the extraction of deleted files and file content by systematically traversing Git commit histories across multiple repositories. For example, the method can use commands such as git log, git rev-list, git fsck, or git reflog to walk through the commit graph, including unreachable commits and dangling objects, in order to identify orphaned or deleted content. The system can be configured to restore file snapshots from their last committed state prior to deletion using commands like git show or git checkout <commit-hash>\hat{ }--<file-path>, thereby enabling reconstruction of files that are no longer present in the current branch view.

In certain embodiments, the scaling 902 can include recovery of orphaned Git objects, such as blobs or trees, that are not directly reachable from any current reference. These objects may contain sensitive information that was once part of the repository but removed through non-standard means, such as a forced push or a rebase. To retrieve such data, the system can optionally invoke low-level Git plumbing commands (e.g., git cat-file, git Is-tree, or git fsck--lost-found) and reconstruct historical repository states based on object hashes. More generally, the scaling 902 can comprise an orchestration layer that automates the handling of a plurality of repositories across distributed computing infrastructure. For example, the system may utilize container orchestration platforms such as Kubernetes or serverless platforms such as AWS Fargate to launch parallel scanning jobs. Each job can independently process a single repository in an isolated, ephemeral execution environment, for example and without limitation a Docker container or virtual sandbox, thereby ensuring scalability and fault isolation.

In some embodiments, temporary environments are dynamically created and destroyed based on workload demand, using infrastructure-as-code tools like Terraform or cloud-native services. For instance, when the system detects that 100 new repositories have been onboarded for a given tenant, it can automatically provision 100 containers or virtual machines to perform concurrent Git history analysis and secret scanning. Upon completion, the resources are deprovisioned to minimize cost and overhead. Optionally, the scaling 902 may include resource prioritization and queuing logic. Repositories may be scored based on risk (e.g., age, number of contributors, or prior secret exposure), and higher-risk repositories may be processed first. In another embodiment, the system may shard large repositories into commit time windows (e.g., process commits from 2020-2022, then 2022-2024) to allow incremental scanning and avoid memory bottlenecks. Alternate embodiments of scaling 902 may also support multi-tenant configurations. For example, repositories belonging to different organizations can be scanned in logically separated environments with access controls, ensuring that customer data is not intermingled. Scaling policies can be set per tenant to enforce resource quotas or geographic processing constraints (e.g., data must remain within a particular region or cloud zone).

In yet another embodiment, scaling 902 can include fault tolerance features, such as automatic retry of failed scans, health checks for worker containers, and persistent tracking of scan state. If a job fails midway through a repository traversal, the system can resume from the last successful commit processed, using metadata stored in a central coordination database.

In typical aspects, the workflow 900 can include an identifying 903 step. The identifying 903 can be an identifying secrets step. For example, the identification 903 can be a multi-layer secret detection including regex (API keys, tokens) entropy or randomness scans, and ML context-based detection. More generally, the identification 903 can run regex scans for standard credentials, apply entropy-based detection for cryptographic artifacts, and use ML models to ambiguous or novel secret patterns (in example, user-defined environment variable keys).

The identifying 903 can be an identifying step configured to detect secrets within retrieved or reconstructed file contents. In one embodiment, the identifying 903 comprises a multi-layered secret detection pipeline that operates on source code, configuration files, and any other retrieved artifacts. For example, the identification 903 may include traditional pattern-matching techniques such as regular expression (regex) scans for well-known secret formats, including but not limited to: AWS access keys (e.g., AKIA [0-9A-Z] {16}), Google API keys, OAuth tokens, Slack tokens, and private RSA or SSH keys (e.g., - - - BEGIN PRIVATE KEY - - - ). These regex patterns may be stored in a configurable rule set that is periodically updated to reflect emerging secret types and naming conventions.

In addition to regex-based detection, the identifying 903 can include entropy-based analysis to detect high-entropy strings that may indicate the presence of cryptographic artifacts, such as symmetric keys, JWTs (JSON Web Tokens), or randomly generated session identifiers. In some embodiments, Shannon entropy or similar metrics can be applied to candidate strings exceeding a certain length threshold (e.g., greater than 16 characters), and strings with entropy values above a predefined cutoff (e.g., 4.5 bits per character) can be flagged for further analysis. To further improve accuracy and reduce false positives, the identifying 903 can incorporate machine learning (ML) models trained to recognize secret patterns based on syntactic and semantic context. For example, the ML model may analyze the surrounding code to determine if a variable named AUTH_SECRET is being assigned a value consistent with a token or key. Context-aware models such as transformers (e.g., BERT or CodeBERT) or LSTM-based models may be trained on labeled examples of secret and non-secret values across different programming languages and file formats. These models can also identify user-defined environment variable keys or configuration patterns that do not follow industry-standard naming but serve similar functional purposes (e.g., MY_INTERNAL_API_KEY or CUSTOM_SALT_VALUE).

In some embodiments, the identifying 903 can perform layered analysis, where candidate secrets detected by regex or entropy analysis are passed to an ML model for validation or de-duplication. Conversely, the ML model may be used for initial classification, and suspected secrets can be passed to a post-processing engine to match against a database of known patterns, hashes, or leaked credentials for confirmation. Alternate embodiments may support pluggable detection engines. For example, customers can supply custom regex rules, ML models, or integration with third-party scanning tools. The system can be configured to execute scans in parallel using a pipeline architecture, where each detection module (e.g., regex engine, entropy scanner, ML classifier) operates as a microservice or containerized task in an orchestrated environment.

In one variation, the identification step 903 may assign a confidence score to each detected secret, based on features such as pattern type, entropy, surrounding code context, and whether the secret appears in a comment, string literal, or environment file. Secrets with scores exceeding a defined threshold may be logged or reported as confirmed exposures, while borderline cases may be flagged for manual review. Further embodiments may allow correlation of detected secrets to their respective commit hashes, file paths, and authors, enabling detailed reporting and attribution. For example, the system may annotate each secret with metadata such as the Git commit ID, line number, repository ID, and timestamp, allowing customers to trace back the origin and propagation of sensitive content. In certain configurations, the identifying 903 process can be tuned based on repository language or file type. For instance, JSON, YAML, .env, .ini, and Docker Compose files may be scanned with different rule sets or models than compiled binary files or large media assets. File-type-specific heuristics can increase precision and reduce unnecessary computation.

In typical aspects, the workflow 900 can include a reporting 904 step. The reporting 904 can be providing actionable insights with commit references, repository details, and secret exposures. For example, the reporting 904 can be generating reports and alerts, such as file path, commit hash, secret type, risk ranking, and integration (Slack, API, etc.).

The reporting 904 can be a reporting and alerting step configured to provide actionable insights regarding detected secret exposures and repository security posture. In some embodiments, the reporting 904 can include the generation of structured reports that associate each detected secret with metadata such as the file path where the secret was found, the commit hash referencing the historical state of the file, the secret type (e.g., API key, private key, password, access token), and a contextual risk score or ranking. These reports can be formatted in machine-readable formats such as JSON, XML, or CSV, or human-readable formats such as PDF or HTML dashboards, depending on the intended recipient system or user. In one example, the reporting 904 may generate a record indicating that a private AWS access key was exposed in config/dev.env at commit 4f7e9ab on Jan. 2, 2025, with a high-risk rating due to the secret being valid and accessible in a publicly available repository. The report may include the repository name, author of the commit, and whether the secret was ever active (e.g., through real-time verification against the target platform's API).

In another embodiment, the reporting 904 can include a classification module that groups secret exposures by severity or type. For example, secrets associated with production environments may be given a higher risk ranking than those linked to test or development environments. Classification may also consider usage patterns, such as whether the secret appears in multiple files or across multiple commits. The reporting 904 may further support real-time or asynchronous notifications through integrations with third-party tools. For instance, upon detection of a high-risk secret, the system may trigger a webhook, send a Slack message to a security operations channel, generate a Jira ticket for remediation, or invoke an API endpoint of a SIEM (Security Information and Event Management) system. Optionally, alerts may include contextual remediation steps, such as “Rotate this key via your AWS IAM console” or “Revoke GitHub personal access token.”

In some embodiments, the reporting 904 can expose a RESTful or GraphQL API that allows clients to query historical and real-time scan results. For example, a DevSecOps platform may periodically poll the API to retrieve recent findings, filter by repository or tenant, and feed the data into a unified risk management dashboard. In alternate embodiments, reporting 904 can be configurable based on customer preferences. For instance, the customer may choose to suppress low-risk findings (e.g., secrets in commented-out code) or enable redaction of detected secrets in logs to avoid additional propagation. Additionally, customers may configure role-based access controls such that only authorized personnel can view or act on detected exposures.

The reporting 904 can also include audit and compliance features. For example, all findings may be timestamped and digitally signed to ensure integrity, and a full audit log of scanning, detection, and alerting actions can be retained for compliance with standards such as SOC 2, ISO 27001, or GDPR. In one variant, the reporting engine can generate periodic compliance summaries such as “Top 10 exposed secret types in Q1” or “Mean time to remediation by repository.” Further, in some embodiments, reports may include correlation across multiple repositories to identify systemic issues or patterns. For example, the reporting engine might detect that the same hardcoded password was committed to three separate repositories over a span of six months, indicating the need for company-wide remediation or developer training.

### § 6.2 Historical SDP Data Recovery Workflow Implementation

The systems and methods of the present disclosure can be broken into a modular workflow. The workflow can be scalable and configured to detect secrets in deleted files. In some aspects, the process can start by leveraging Git's version control capabilities to traverse commit histories, extract deleted files, and then run secret detection algorithms. The following is provided for example only to depict optional phases of the systems and methods of the present disclosure.
Stage 1: Setting Up Targets: input repositories are gathered based on pre-existing workflows. Repositories can be cloned into isolated environments and partitioned across compute nodes for parallel processing. In this initial stage, input repositories can identify and gathered based on pre-existing workflows, such as those defined by continuous integration/continuous deployment (CI/CD) pipelines, infrastructure-as-code templates, or configuration management tools. In one embodiment, the system automatically detects and selects repositories by analyzing workflow orchestration metadata (e.g., GitHub Actions, GitLab CI, Jenkinsfiles). Once identified, repositories can be cloned into isolated execution environments, such as containers, virtual machines, or sandboxed serverless functions, to ensure reproducibility and prevent cross-contamination. In alternative embodiments, the repositories may be shallow-cloned or fetched using sparse-checkout techniques to minimize resource usage. To enhance scalability and efficiency, the repositories may be partitioned across multiple compute nodes based on predefined rules-such as size, language, or dependency tree complexity-enabling parallel or distributed processing. For example, Python-based repositories may be processed on a subset of nodes with specific runtime environments, while Node.js repositories are handled separately. Additionally, prioritization algorithms can be applied to sequence or batch the processing of repositories according to risk level, update frequency, or user-defined importance criteria.
Stage 2: Traversing GIT Commit History: to retrieve deleted files, the system can utilize Git internals and focus on reconstructing the repository's history across all branches. The following non-limiting list of commands and strategies can be applied:

Identify Deleted Files: Use Git logs to identify files that were intentionally deleted from the working tree: (This command filters for commit entries that flagged files as “deleted.”)
git log--diff-filter=D--name-only

Recover Deleted Files: Use the ‘git show’ command to restore the content of deleted files at specific commits:
git show <commit-hash>:<file-path>

Check Parent-Child Diff: Diffing parent-child commits helps identify changes to file states, including cases where files are moved or partially deleted:
git diff<parent-commit><child-commit>

Unpack Objects: For repositories storing large assets, ‘.pack’ files are unpacked:
git unpack-objects<.git/objects/pack/pack-<SHA>.pack

Find Dangling Objects: Leverage ‘git fsck’ for files that exist as unreachable objects but were referenced historically:
git fsck--full--unreachable--dangling

To retrieve deleted or otherwise inaccessible files, the system can be configured to traverse the full commit history of one or more Git repositories. This can include leveraging Git internals to reconstruct the state of the repository across all branches, tags, and other references. In one embodiment, the system performs a depth-first traversal of the commit DAG (directed acyclic graph), starting from the latest commits on each branch and walking backward in time to locate file deletions, renames, or content overwrites. In another embodiment, the system may employ a breadth-first strategy to prioritize more recent deletions, which are more likely to be relevant. To maximize coverage, orphaned commits, such as those from rebased or force-pushed branches, can be recovered using Git's reflog, fsck, or by directly inspecting the .git/objects directory. The system may apply a non-limiting set of commands and techniques including but not limited to: git log--all--diff-filter=D, to identify deleted files; git rev-list combined with git Is-tree for commit-by-commit inspection; and git checkout<commit>--<path> to restore deleted files at specific revisions. In some embodiments, parallelized traversal of multiple branches or commits can be employed to reduce analysis time, particularly for large monorepos or repositories with extensive branching histories. Additionally, heuristic or ML-driven filters can be integrated to prioritize commits that are more likely to contain sensitive or high-value content, thereby optimizing system performance.
Stage 3: Secret Scanning Algorithms: Data recovered from the commit history is scanned using a combination of rule-based, entropy based, and machine learning paradigms. In some embodiments, the system employs a multi-faceted approach to detecting sensitive information or secrets embedded within code repositories. One technique involves the use of regular expressions (regex) to identify well-known token patterns. For example, the system may scan for strings matching predefined formats such as AWS Identity and Access Management (IAM) keys (e.g., patterns like AKIA [0-9A-Z] {16}), OAuth access tokens, Firebase authentication tokens, and database connection strings. These regular expressions can be dynamically updated or extended to include new token formats as threat models evolve. In addition to pattern matching, the system may incorporate entropy-based detection to identify high-entropy strings that are statistically likely to be cryptographic keys, secrets, or tokens. Techniques such as Shannon entropy calculation or compression-resistance metrics (e.g., using zlib) can be used to flag anomalous strings that do not conform to typical human-readable data. Furthermore, machine learning models may be employed to enhance detection accuracy by analyzing contextual cues within the source code, such as variable names, assignment patterns, or surrounding comments. For instance, a model might flag a variable labeled API_KEY or detect sequences of characters that deviate from standard programming conventions, particularly when evaluated at runtime or during static analysis. These detection methods can operate individually or in combination to provide robust and adaptive scanning capabilities.

In general aspects, the present disclosure provides a method implemented by a cloud-based system. In one embodiment, the system initiates a process by querying a software development platform (SDP), for example and without limitation GitHub, GitLab, Bitbucket, or an internal version control system, for account-level and repository-specific metadata. This querying may be driven by a customer identifier, organization name, or domain-specific access credentials, enabling scoped discovery across all accessible repositories and related artifacts. Once the relevant repositories are enumerated, the system proceeds to identify content that previously existed but is no longer present in the current state of the platform. This may include deleted files, removed code snippets, overwritten configurations, or purged secrets. Identification may be achieved through analysis of commit history, pull request diffs, or archival snapshots where available.

After locating such deleted or superseded content, the system can reconstruct the previously existing content, which may involve checking out historical commits, parsing diffs, or rebuilding full file structures from object-level data in the repository's internal DAG. In some embodiments, the system leverages Git internals, such as git log, git fsck, or access to reflog data, to recover orphaned or unreachable content.

Following reconstruction, the system can perform automated analysis of the recovered data for indicators of sensitive information, including but not limited to access credentials, API tokens, private keys, personally identifiable information (PII), or proprietary business logic. Detection mechanisms may include regular expression scanning, entropy analysis, machine learning classifiers, or contextual heuristics based on file names and variable usage patterns.

Finally, the system can generate a comprehensive report detailing the findings. This report may include metadata such as file names, commit hashes, authorship information, timestamps, severity ratings, and remediation recommendations. In some embodiments, the report can be integrated into existing security dashboards, exported in standardized formats (e.g., JSON, PDF, SARIF), or automatically routed to designated stakeholders via secure channels such as email, webhook, or ticketing systems.

In one embodiment, the system begins by collecting target repositories through the identification of repositories associated with a particular customer. This association can be established using a predefined workflow, such as metadata integration with a customer's internal configuration management system, CI/CD pipeline descriptors, or organization-level repository tags maintained within the software development platform (SDP). For example, the system may automatically query all repositories under a known GitHub organization or Bitbucket workspace linked to a customer's domain or service account. Alternatively, in cases where repositories are public or not directly managed under the customer's organization, the system may apply separate association methods, such as cross-referencing contributor email domains, commit authorship metadata, code ownership files (e.g., CODEOWNERS), or custom-defined attribution rules stored in a customer registry. In some embodiments, the system may leverage machine learning models to infer customer association based on patterns in repository naming conventions, code similarity, or historical contribution behavior. The repository collection process can be conducted once during initialization or executed on a recurring basis to account for newly created or recently modified repositories. This step ensures that all relevant codebases, whether private, forked, archived, or publicly available, are correctly attributed and prepared for subsequent analysis.

In one embodiment, the system can clone each identified repository into an isolated processing environment for reproducibility, security, and process isolation. These environments may include containers (e.g., Docker), virtual machines, sandboxed serverless functions, or chroot-based execution spaces, depending on the deployment context and resource availability. Isolation is critical to prevent cross-contamination between repositories, particularly when sensitive or untrusted code is analyzed. Once cloned, the repositories are distributed across a plurality of compute nodes, which may include physical servers, virtual machines in a cloud environment, or nodes within a Kubernetes cluster, to enable parallel execution of subsequent processing tasks such as scanning, analysis, or code transformation. In one example, the system may use a load-balancing algorithm to partition repositories based on size, language, or historical scan duration to optimize throughput. In another embodiment, repositories with known high-risk characteristics (e.g., frequent secrets exposure or complex dependency graphs) may be prioritized for assignment to higher-performance nodes. Additionally, orchestration tools such as Kubernetes, Apache Mesos, or custom scheduling frameworks may be used to manage node allocation, resource scaling, and fault tolerance.

In one embodiment, identifying previously existing content involves traversing the complete commit history across all branches of each cloned repository. This traversal includes mainline branches (e.g., main, master) as well as feature, release, and hotfix branches to ensure that no historical content is overlooked. The system walks through each commit graph in a chronological or topological order and analyzes the differences between parent and child commits to detect changes in file states, such as deletions, renames, or relocations. This analysis can be performed using Git commands like git diff, git log--diff-filter=D, or low-level object inspection through Git plumbing commands (e.g., git cat-file, git Is-tree). In some embodiments, the system constructs an in-memory representation of the repository state at each commit and performs a delta analysis to identify files that existed in prior states but are missing or altered in subsequent ones. Alternative embodiments may use heuristic optimizations, such as skipping merge commits or parallelizing diff computations across branches, to reduce processing time. For enhanced accuracy, the system may also analyze commit metadata, including author, timestamp, and commit message, to contextualize deletions and identify files likely removed due to misconfiguration, accidental exposure, or intentional secret removal.

In one embodiment, reconstructing the previously existing content involves a multi-step process that includes both standard and advanced techniques for retrieving deleted or otherwise inaccessible data from a version control system. Specifically, the system may restore file snapshots from specific commits by referencing commit hashes or file paths associated with deletions. This can be accomplished using standard Git commands such as git checkout, git show, or git restore, which allow the retrieval of file states as they existed at particular points in the commit history. In addition, the system may recover unreachable or orphaned content, including files that were deleted and no longer referenced by any branch, by leveraging Git internals. This can include the use of git fsck to identify dangling blobs and commits, as well as object unpacking techniques that extract raw data from Git's object database. For example, the system may iterate through the .git/objects directory or use commands like git cat-file to inspect and reconstruct the contents of loose or packed objects that are not associated with any current references. In some embodiments, the system can apply automated heuristics to associate recovered orphaned objects with known file paths or timestamps, thereby improving the contextual fidelity of the reconstruction. Alternative implementations may include integration with reflog analysis, subtree reassembly, or use of forensic recovery tools that scan low-level storage for remnants of deleted Git data.

In one embodiment, analyzing the reconstructed content involves applying a set of predefined regular expression (regex) rules designed to detect known patterns associated with sensitive information. This includes, but is not limited to, AWS Identity and Access Management (IAM) keys (e.g., AKIA [0-9A-Z] {16}), OAuth access tokens, Firebase service credentials, and database connection strings (e.g., JDBC URIs or MongoDB connection strings). The system may scan each reconstructed file line-by-line or as a full text buffer, applying multiple regex patterns in parallel to increase performance. In one implementation, each match may be tagged with a corresponding secret type, confidence score, and file context to support downstream reporting and remediation. As an alternative embodiment, the system may augment regex-based detection with context-aware analysis, such as checking whether matched strings appear in configuration files (e.g., .env, settings.py, config.js) or are assigned to variables with suspicious names like API_KEY, SECRET, or TOKEN. To reduce false positives, the system may also apply whitelisting, entropy scoring, or machine learning-based classifiers trained on labeled examples of real-world secret exposures. Additionally, detection rules may be dynamically updated based on emerging threat patterns, customer-defined policies, or integration with third-party secret scanning services.

In one embodiment, the system performs entropy analysis by calculating an entropy score for segments of the reconstructed content to identify high-entropy sequences that may indicate the presence of cryptographic artifacts, such as API keys, access tokens, private keys, or other forms of sensitive encoded data. This may be accomplished using Shannon entropy, which quantifies the unpredictability or randomness of a character distribution within a given string. For instance, strings with evenly distributed alphanumeric characters typically yield higher entropy scores, often characteristic of securely generated secrets. In another embodiment, the system may apply compression-based techniques, such as measuring compression resistance using algorithms like zlib or gzip, under the principle that high-entropy data compresses poorly due to its lack of redundancy. The content may be divided into fixed-size or sliding-window segments (e.g., 20-100 characters), and each segment is evaluated individually to flag anomalously high-entropy values. Threshold values for entropy scores can be empirically defined or dynamically adjusted based on file type, historical false positive rates, or content-specific heuristics. To improve accuracy, the entropy-based detection can be combined with contextual filters (e.g., file path relevance, presence of assignment statements) or applied selectively to files likely to contain secrets (e.g., .env, .json, config.yaml). In some implementations, this analysis may be parallelized across multiple compute nodes for scalability or integrated with other detection methods (e.g., regex, machine learning) to form a multi-factor classification system for sensitive data exposure.

In one embodiment, the system enhances secret detection by applying one or more machine learning models that have been trained to identify user-defined or anomalous secret-related identifiers within the reconstructed content. These models analyze variable names, string patterns, and token formats that deviate from standard programming conventions or known secret formats. For example, the models may flag variable names such as API_KEY, SECRET_TOKEN, or less obvious custom identifiers that follow project-specific naming schemes. The training data for such models can include labeled datasets comprising both legitimate code elements and known secret exposures, enabling the models to learn distinguishing features. Alternative embodiments may employ supervised learning techniques, including neural networks, support vector machines, or decision trees, as well as unsupervised anomaly detection methods to detect unusual token formats or irregular patterns that suggest the presence of secrets. The system may further incorporate contextual features such as code syntax, file type, or proximity to known secret-containing constructs to improve prediction accuracy. Additionally, the machine learning models can be periodically retrained using feedback from manual reviews or newly discovered secret types, thereby adapting to evolving coding practices and threat landscapes. In some implementations, these models operate in conjunction with regex and entropy-based detection methods to form a comprehensive multi-layered secret detection framework, reducing false positives and enhancing sensitivity.

In one embodiment, the system outputs metadata for each detected secret identified during the analysis process. This metadata includes without limitation, the file path indicating the location of the secret within the repository, the commit identifier (e.g., commit hash) that references the specific version of the file containing the secret, the type of secret detected such as AWS IAM keys, OAuth tokens, or database credentials, and a risk classification that categorizes the severity or sensitivity of the secret based on predefined criteria or dynamic scoring algorithms. Alternative embodiments may extend this metadata to include additional contextual information, such as the branch name, author of the commit, timestamp of the commit, or confidence scores generated by detection algorithms. The risk classification may be determined using rule-based heuristics, entropy scores, machine learning confidence outputs, or integration with external threat intelligence databases. In some implementations, the metadata is formatted in standardized reporting formats such as JSON, XML, or CSV to facilitate downstream processing, auditing, or integration with security information and event management (SIEM) systems. Additionally, the system may provide options to output aggregated reports summarizing detected secrets by repository, severity level, or time period, enabling users to prioritize remediation efforts effectively.

In one embodiment, the system integrates with external communication systems to provide timely notifications regarding detected secrets. This integration involves connecting to various alerting mechanisms, such as Slack, Microsoft Teams, email, SMS, or other messaging platforms, enabling the system to notify users or security teams of identified secrets in near real-time. The notification process can be triggered automatically upon detection, including relevant metadata such as repository name, file path, secret type, and risk classification within the alert message. Alternative embodiments may support configurable alerting rules, allowing users to define thresholds for notification frequency, severity levels that warrant alerts, or specific projects to monitor. The system may also leverage APIs or webhook interfaces provided by communication platforms to customize message formatting, include interactive elements like buttons for acknowledgment or remediation tracking, or integrate with incident management tools such as PagerDuty or Jira. In some implementations, notifications can be batched and sent as periodic summaries instead of immediate alerts to reduce alert fatigue. Furthermore, the system may support secure transmission of notifications through encrypted channels and implement role-based access controls to ensure that sensitive information is only shared with authorized personnel.

### § 6.3 Process for Detecting Secretes in Deleted SDP Repositories

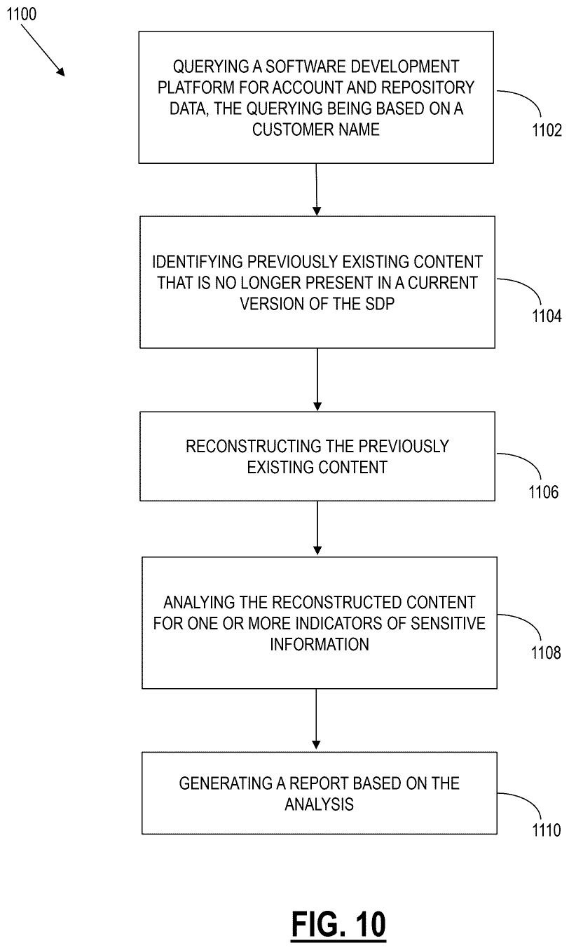

Turning now to FIG. 10, a second process 1100 for detecting secrets in deleted software development platform repositories is shown and described. In some aspects, the process 1100 can include querying 1102 a software development platform (SDP) for account and repository data, the querying being based on a customer name. The second process 1100 can include identifying 1104 previously existing content that is no longer present in a current version of the SDP. The second process 1100 can include reconstructing 1106 the previously existing content. The second process 1100 can include analyzing 1108 the reconstructed content for one or more indicators of sensitive information. The second process 1100 can include generating 1110 a report based on the analysis.

In some aspects, the second process 1100 can include further comprising collecting target repositories by identifying repositories associated with a customer using a predefined workflow or a separate method for associating public repositories with a customer identity. The second process 1100 can include further comprising cloning each repository into an isolated processing environment and distributing the repositories across a plurality of compute nodes for parallel execution. The second process 1100 can include wherein identifying previously existing content comprises traversing a full commit history across all branches of each repository and analyzing differences between parent and child commits to detect deleted or moved files. The second process 1100 can include wherein reconstructing the previously existing content further comprises restoring file snapshots from specific commits using references to deleted files, and recovering unreachable or orphaned content using Git internal commands, including git fsck and object unpacking.

In some aspects, the second process 1100 can include wherein analyzing the reconstructed content comprises applying a set of regular expression rules to detect specific types of secrets including, but not limited to, AWS IAM keys, OAuth access tokens, Firebase credentials, and database connection strings. The second process 1100 can include wherein analyzing the reconstructed content further comprises calculating an entropy score for segments of the content using Shannon entropy or compression-based techniques to detect high-entropy sequences indicative of cryptographic artifacts. The second process 1100 can include wherein analyzing the reconstructed content further comprises applying one or more machine learning models trained to identify user-defined or anomalous secret-related identifiers, including variable names and non-standard token formats. The second process 1100 can include wherein generating the report comprises outputting, for each detected secret, metadata including at least one of: a file path, a commit identifier, a type of secret, and a risk classification. The second process 1100 can include wherein generating the report further comprises integrating with external communication systems, including alerting mechanisms such as Slack or other messaging platforms, to notify users of detected secrets in near real-time.

The process 1100 can include any of: collecting target repositories by identifying repositories associated with a customer, cloning each target repository into an isolated processing environment and distributing the repositories across a plurality of compute nodes, analyzing a difference between one or more commits to detect any of deleted or moved files, restoring file snapshots and recovering unreachable content, applying a set of regular expression rules to detect specific types of secrets, calculating a score for segments of the content, applying one or more machine learning models trained to identify user-defined or anomalous secret-related identifiers, the report defines metadata including at least one of: a file path, a commit identifier, a type of secret, and a risk classification, and integrating with external communication systems to notify users of detected secrets in near real-time.

### Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### CONCLUSION

As used herein, including in the claims, the phrases “at least one of” or “one or more of” a list of items refer to any combination of those items, including single members. For example, “at least one of: A, B, or C” covers the possibilities of: A only, B only, C only, a combination of A and B, a combination of A and C, a combination of B and C, and a combination of A, B, and C. Additionally, the terms “comprise,” “comprises,” “comprising,” “include,” “includes,” and “including” are intended to be non-limiting and open-ended. These terms specify essential elements or steps but do not exclude additional elements or steps, even when a claim or series of claims includes more than one of these terms.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

Although operations, steps, instructions, and the like are shown in the drawings in a particular order, this does not imply that they must be performed in that specific sequence or that all depicted operations are necessary to achieve desirable results. The drawings may schematically represent example processes as flowcharts or flow diagrams, but additional operations not depicted can be incorporated. For instance, extra operations can occur before, after, simultaneously with, or between any of the illustrated steps. In some cases, multitasking and parallel processing might be beneficial. Furthermore, the separation of system components described should not be interpreted as mandatory for all implementations, as the program components and systems can be integrated into a single software product or distributed across multiple software products.

What is claimed is:

1. A method implemented by a cloud-based system, the method comprising steps of:
querying a Software Development Platform (SDP) for account and repository data, the querying being based on a customer name;
identifying previously existing content that is no longer present in a current version of the SDP;
reconstructing the previously existing content;
analyzing the reconstructed content for one or more indicators of sensitive information; and
generating a report based on the analyzing.

2. The method of claim 1, further comprising collecting target repositories by identifying repositories associated with a customer.

3. The method of claim 2, further comprising cloning each target repository into an isolated processing environment and distributing the repositories across a plurality of compute nodes.

4. The method of claim 1, further comprising analyzing a difference between one or more commits to detect any of deleted or moved files.

5. The method of claim 1, further comprising restoring file snapshots and recovering unreachable content.

6. The method of claim 1, further comprising applying a set of regular expression rules to detect specific types of secrets.

7. The method of claim 1, further comprises calculating a score for segments of the content.

8. The method of claim 1, further comprising applying one or more machine learning models trained to identify user-defined or anomalous secret-related identifiers.

9. The method of claim 1, wherein the report defines metadata including at least one of: a file path, a commit identifier, a type of secret, and a risk classification.

10. The method of claim 1, further comprising integrating with external communication systems to notify users of detected secrets in near real-time.

11. A non-transitory computer-readable medium comprising instructions that, when executed, cause one or more processors to perform steps of:
querying a Software Development Platform (SDP) for account and repository data, the querying being based on a customer name;
identifying previously existing content that is no longer present in a current version of the SDP;
reconstructing the previously existing content;
analyzing the reconstructed content for one or more indicators of sensitive information; and
generating a report based on the analyzing.

12. The non-transitory computer-readable medium of claim 11, further comprising collecting target repositories by identifying repositories associated with a customer.

13. The non-transitory computer-readable medium of claim 12, further comprising cloning each target repository into an isolated processing environment and distributing the repositories across a plurality of compute nodes.

14. The non-transitory computer-readable medium of claim 11, further comprising analyzing a difference between one or more commits to detect any of deleted or moved files.

15. The non-transitory computer-readable medium of claim 11, further comprising restoring file snapshots and recovering unreachable content.

16. The non-transitory computer-readable medium of claim 11, further comprising applying a set of regular expression rules to detect specific types of secrets.

17. The non-transitory computer-readable medium of claim 11, further comprises calculating a score for segments of the content.

18. The non-transitory computer-readable medium of claim 11, further comprising applying one or more machine learning models trained to identify user-defined or anomalous secret-related identifiers.

19. The non-transitory computer-readable medium of claim 11, wherein the report defines metadata including at least one of: a file path, a commit identifier, a type of secret, and a risk classification.

20. The non-transitory computer-readable medium of claim 11, further comprising integrating with external communication systems to notify users of detected secrets in near real-time.
